(19) United States
(12) Patent Application Publication
(10) Pub. No.: US 2010/0021872 A1
(43) Pub. Date: Jan. 28, 2010

(54) PROCESS OF LEARNING PROCESS IMPROVEMENT TECHNIQUES

(75) Inventor: William M. Hathaway, Powell, OH (US)

Correspondence Address: MICHAEL BEST & FRIEDRICH LLP, 100 E WISCONSIN AVENUE, Suite 3300, MILWAUKEE, WI, 53202, US

(73) Assignee: MoreSteam.com LLC, Lewis Center, OH (US)

(21) Appl. No.: 12/177,565

(22) Filed: Jul. 22, 2008

(51) Int. Cl. G09B 19/00

(52) U.S. Cl. 434/219

(57) ABSTRACT

A method of simulating a process. Students are assigned a role related to the process and conduct interviews and investigations via electronic mail to document the process. During the simulation, the students learn the steps involved in the process, and the students learn what steps delay the process and identify the “choke” points in the process. With this information, the students can take action to alter and/or avoid those steps to improve the process.

### BACKGROUND

“Six Sigma” refers to a popular methodology for improving and maintaining processes to achieve business success. “Six Sigma” commonly refers to a problem solving approach or business initiative that uses the Define-Measure-Analyze-Improve-Control (DMAIC) roadmap of problem solving to identify, initiate, and complete a series of projects targeting processes that are not operating satisfactorily. More particularly, Six Sigma practitioners will refer to such projects as seeking to reduce the variation in process outputs and to assure meeting of customer requirements. Likewise, “Lean Methods” is a phrase that generally describes a set of problem solving tools and techniques used to reduce waste associated with the flow of materials and information in a process from beginning to end. Typical forms of waste targeted by use of Lean Methods include (1) defects, which lead to rework and/or scrap; (2) overproduction; (3) transportation; (4) waiting; (5) inventory; (6) motion; and (7) processing. Lean Methods can be employed within the DMAIC framework to augment Six Sigma tools when appropriate.

The principles of continuous process improvement, including those of Lean and Six Sigma can be applied in virtually any working environment. Accordingly, all kinds of organizations, from manufacturers, service providers, non-profit organizations, government agencies, to even schools, have found success applying process improvement techniques, such as Lean and Six Sigma to their enterprise. The gains process improvements can help achieve include increased profitability (either by reduced costs or enhanced revenue), improved social service outcomes or worker safety, and improved environmental impact, to name a few.

The DMAIC framework and Lean Methods each entail a variety of activities leading to an improved process. A common link among them is data—using data to make decisions, to understand customer requirements, and to assure that processes are meeting those requirements. Implementing a continuous improvement initiative in an organization typically entails understanding the organization's objectives, familiarizing the people who operate the organization with the tenets of the continuous improvement initiative, and then working through DMAIC and Lean Methods problem solving techniques. Understanding the customer and the customer's requirements, focusing on meeting the customers' requirements, gathering data, and challenging decisions made without supporting data, all become second nature in organizations utilizing Six Sigma methodologies.

### SUMMARY

The ability to practice a new set of skills is key in developing and applying the skill-set under real-world circumstances, including skills in applying continuous improvement principles. The present invention relates to a method for simulating a process, and affords opportunities to practice skills needed to understand and improve processes. As such, the invention provides a method that can be used by organizations and individuals to learn and perfect process improvement skills in a relatively inexpensive, safe, repeatable and realistic manner.

In this regard, it can be difficult to describe or explain a particular process to a person unfamiliar with the process, and this difficulty becomes harder to overcome with increases in process complexity. Similarly, if one is unfamiliar with a process, it can be difficult to ascertain the nature of the process and to describe or document it.

In many circumstances, the process steps can be observed, e.g., in a manufacturing process the materials and actions of man and machine can be followed and understood by “walking” through the process. In other circumstances, however, the process is not observable. For example, in transactional environments, the work that is done may in electronic form and results in an intangible service. Transactional processes are often “invisible” because there is not a physical assembly line or shop floor organized to produce the resultant product. Rather, invisible processes can result where the process steps involve transformation, assessment or responses to presented information, and such steps simply prompt additional communications that may or may not have a tangible record. In such circumstances, the invisible process may be carried out by individuals who understand and carry out their individual step in the overall process stream but who are unaware of the overall process or other parts of the process. There may also be a lack of understanding of the overall desired outputs of the process, and an absence of data relating to the process output or steps within the process. Indeed, this absence of an overall view of the process can be problematic for organizations who carry out transactions with customers because it is the customer who is most likely to experience the overall process rather than the individuals who carry it out.

The invention provides a method for conducting a process or series of process steps by two or more participants in such a way that the process is invisible to the participants and observers of the process. Upon simulating the process steps, the participants must then ascertain the nature of the process by conducting interviews and investigations, and using various continuous improvement tools and techniques to document the process and the process steps.

In one embodiment, the method for conducting a process involves communications among the participants via electronic mail. The email trail created by the participants serves as data-rich documents from which the nature of the process can be understood. To gain insight, the participants or students ascertain the steps involved in the process, and then can begin to understand what aspects of the process represent either a form of waste or error, and to identify the constraints in the process. With this information, the students then can make decisions and alter and/or avoid those steps to streamline or otherwise improve the process.

More specifically, the present invention relates to a method of simulating a process for learning ways to reduce errors in the particular process. For example, the process of negotiating a commercial lease can have many variables, and the process of negotiating a lease is almost never the same for new stores. By learning how the process of negotiating for a lease occurs and understanding the various steps involved, a student of the process can gain insight into the process steps and how to eliminate the points in the process that constrain the process outputs or that constitute unnecessary or wasteful steps, or to at least reduce the amount of time to complete the negotiation process.

The present invention provides a method of simulating a process. The method comprises developing preliminary information defining the process, assigning a role to each of a plurality of participants, transmitting a set of instructions relating to the assigned role to the corresponding participant, transmitting only electronic mail messages between the participants to carry out the process, storing the electronic mail messages, and reviewing the electronic mail messages to determine the nature of the process and how the process can be improved.

The present invention also provides a method of conducting a series of process steps to simulate a process. The method comprises transmitting preliminary information related to the process to a plurality of students, assigning a role to each of the plurality of students, the roles related to the process, transmitting a set of instructions relating to the assigned role to the corresponding student, transmitting only electronic mail messages between the students to carry out the process, storing the electronic mail messages, reviewing the stored electronic mail messages to determine how the process can be improved, re-running the process steps with the identified improvements and determining whether the identified improvements improved the re-run process.

Other aspects of the invention will become apparent by consideration of the detailed description and accompanying drawings.

### BRIEF DESCRIPTION OF THE DRAWINGS

FIG. 1 is a schematic diagram of a system adapted to practice a method of the invention.

FIG. 2 is a schematic diagram of a system adapted to practice a method of the invention.

FIG. 3 is a schematic diagram of a method for practicing an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. The terms connected and coupled and variations thereof herein are not restricted to physical and mechanical connections or couplings.

As used herein the term “computer” is not limited to a device with a single processor, but may encompass multiple computers linked in a system, computers with multiple processors, special purpose devices, computers or special purpose devices with various peripherals and input and output devices, software acting as a computer or server, and combinations of the above. In general, computers accept and process information or data according to instructions (i.e., computer instructions).

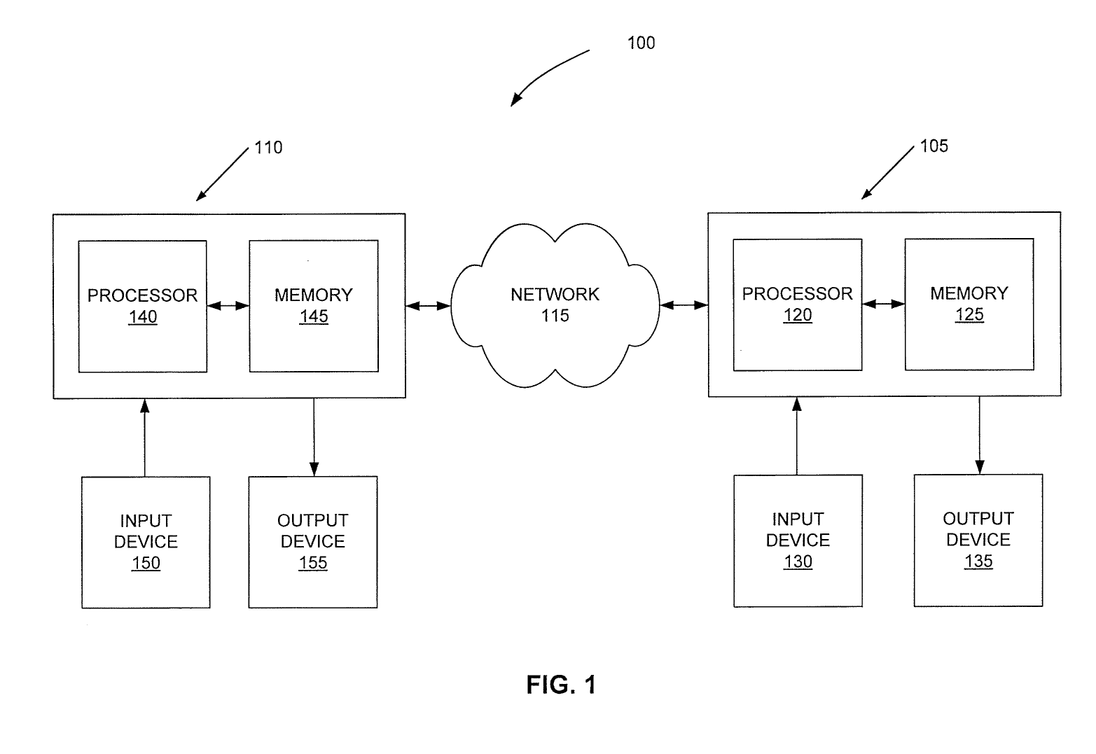

FIG. 1 schematically illustrates an exemplary system 100 for practicing the invention. In general, the system 100 includes a first computer 105 (referred to below as the client computer, client, or local computer) in communication with a second computer 110 (referred to below as the server computer, server, or remote computer) over a network 115. As explained in greater detail below, the system 100 can be used to deliver content to a user of the system 100 (e.g., instructional content). As described below, the requirements of the system 100 are flexible.

In particular, while only one client 105 and only one server 110 are shown in FIG. 1, the system 100 can include multiple servers 110 and/or multiple clients, 105 the number of clients 105 being limited only by the capacity of the network 115 and the servers 110. The client 105 includes a processor 120, memory 125 (e.g., RAM, program storage, data storage, etc.), and one or more input/output devices 130 and 135 (e.g., disk drive, optical drive, display, printer, touch screen, keyboard, mouse etc.). Example types of client computers include, but are not limited to, an electronic device capable of accessing the Internet including the World Wide Web (e.g., an Internet appliance), a handheld device, a laptop computer, a desktop computer, etc. Those of ordinary skill in the art will recognize that the terms “processor,” “client computer,” “browser,” “network” and the like are broadly defined and can apply to a wide variety of devices. The client 105 typically includes an operating system adapted to support a graphical user interface (GUI) and adapted to run a browser. The browser may be a web browser such as Netscape Navigator, Microsoft Explorer, Mozilla Firefox or a program with similar functionality that may access information from the server 110. The client 105 receives input from the input device 130 (e.g., a keyboard, a mouse, a CD-ROM, etc.) and communicates outputs to output device 135 (e.g., a display, a printer, a read/write device, etc.). Of course, the input/output devices can include a device that communicates inputs and receives outputs (e.g., a touch screen, a read/write device, etc.) The client 105 also receives inputs and communicates outputs through one or more auxiliary ports, such as a USB (universal serial bus) port, a network interface, a wireless port, and/or an embedded web interface.

The client 105 is connected to the network 115, which can be any suitable local network (LAN) or wide-area network. The server 110 can include a processor 140, memory 145, one or more input/output devices 150 and 155, and one or more auxiliary ports. The server 110 includes a server interface, such as a common gateway interface (CGI) or Internet Server Application Programming Interface (ISAPI), and a web site. The web site includes a graphical user interface module, a knowledge base, HTML, XML, and/or other files, and associated components.

Files stored in the memory 125 or input devices 130 of the client computer 105 are said to be stored locally. Files stored in the memory 145 or input devices 150 of the server 110 are said to be stored remotely.

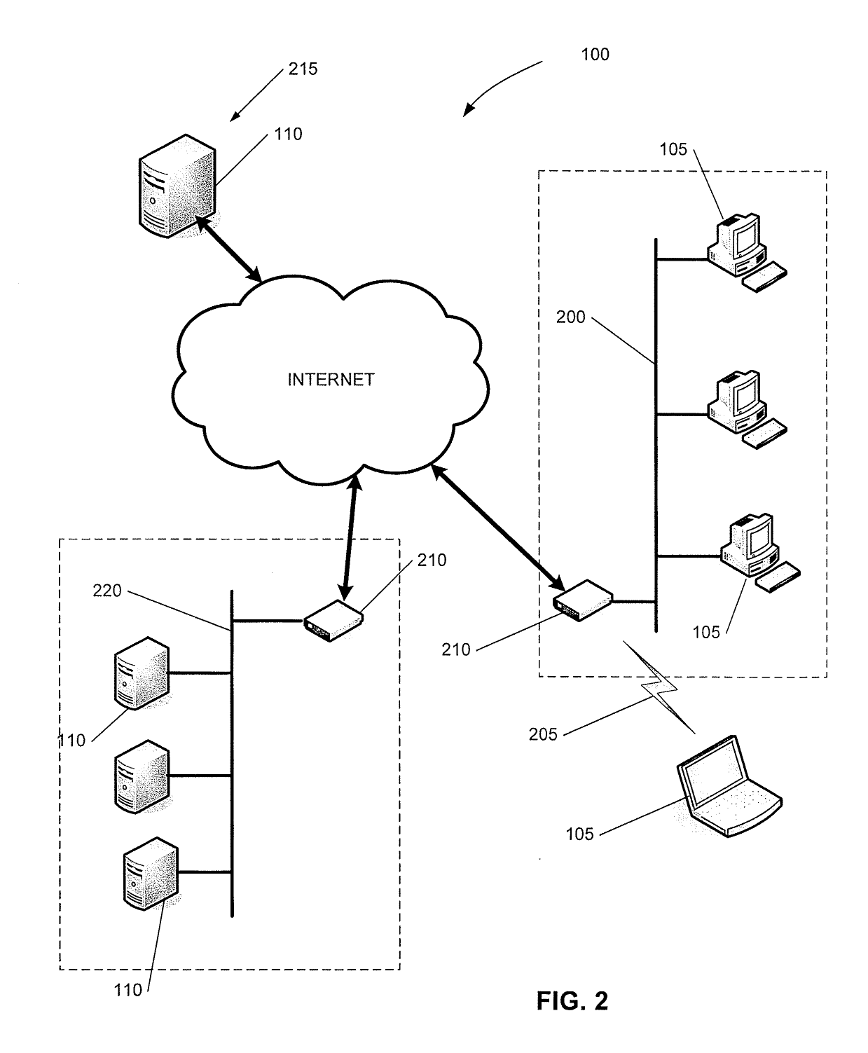

A second construction of the system 100 is shown in FIG. 2. A plurality of clients 105 reside on a LAN 200. Additional clients 105 can access the LAN 200 via a wireless interface 205. The LAN 200 includes a modem 210 for accessing the Internet. The LAN 200 can also include an intranet. The clients 105 access the Internet or intranet using Internet protocols. The clients 105 are adapted to communicate with the server 110 using Internet protocols such as TCP/IP (Transmission Control Protocol/Internet Protocol). The servers 110 can be standalone servers 215 or can reside on a LAN 220. Not all of the components illustrated in FIGS. 1-2 are required for some operations of the invention.

While learning Six Sigma techniques via online courses, student participants can conduct a simulation of a business process to learn how to apply techniques and tools to reduce errors and variation in the simulated process. The simulated process is amenable to application of process improvement techniques such as lean methods for accelerating process flows and reducing waste, and to methods commonly associated with six sigma process improvement. The skills and techniques learned during the simulation can be applied to real-world situations to improve quality by reducing variation, identifying process improvements, and reducing cycle time. Generally speaking, using a simulation of a business process provides a time-compressed and low cost representation of a comparable “real-world” process, and affords opportunities for participates to learn and practice valuable skills and gain experience. A simulation attempts to reflect reality to help students practice analysis and responses to presented circumstances with the objective of preparing the participants to effectively address similar circumstances when they arise in the workplace.

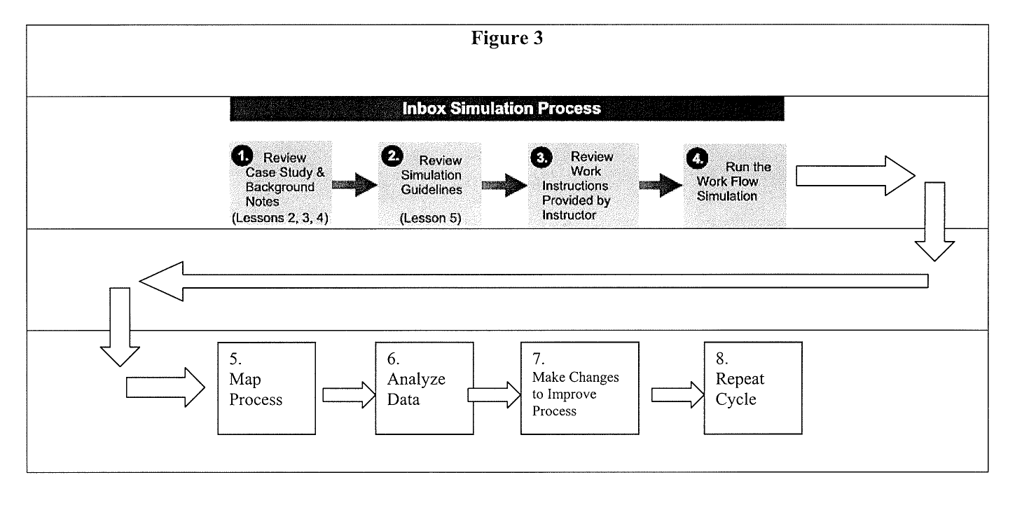

In one embodiment, the invention provides a role-based simulation of a business process, wherein the participants perform a pre-defined “job” within a transactional process and wherein the work flows between the participants via email. The participants then apply process improvement techniques to the process steps. The process simulation is then re-run in a manner incorporating the improvements to the process steps to ascertain the effect of the changes. FIG. 3 illustrates a flow chart showing the steps of providing information to the participants, having the participants conduct respective process steps, thereby generating process data, gathering and analyzing the data, applying process improvement techniques to the simulated business process, and then re-running the revised process. The invention thus provides a simulation exercise utilizing an electronic workflow or “invisible” process that cannot be viewed by an observer. Further in this regard, the participants may be unaware of each other's roles and decisions made according to each role's responsibilities and decision criteria. As such, the overall nature of the process simulated by the participants is also invisible to the participants themselves. The simulated workflow and the activities used by the participants to understand and document the workflow is thus designed to practice a comprehensive set of lean six sigma tools and methods within a simulated real-world transactional environment, where the workflow is virtual rather than tangible. By employing a simulation using an electronic or otherwise hidden workflow, the participants experience first hand the application of process improvement concepts within a setting that closely mirrors the “knowledge workplace.”

More particularly, the participants either directly access a client computer 105 to obtain preliminary background information from a website stored on the server 110. In the alternative, the participants can be provided background information from an instructor overseeing or facilitating the conduct of the simulation. The background information is preferably developed prior to running the simulation but is unknown to the participants until immediately prior to conducting the simulation. The information generally includes instructions for assigning or selecting roles for each student participant and an introduction to the business process to be simulated by the student participants. In one embodiment of the invention, the process simulated by the participants is a series of process steps involved in the hypothetical negotiation of a commercial lease. The process steps are carried out by participants who serve in respective roles or capacities for conducting the simulated process.

After the preliminary information is provided to the participants, they determine who will play each role. For example, in the negotiating a lease scenario, the students may select to play the role of attorney, buyer, or landlord. Alternatively, the instructor may assign a role to each student. Each student then receives a set of instructions specific to their role in which to carry out the tasks of that role. The instructions for the other roles are not shared with the student. The instructions given to each student can be varied by the instructor for each simulation to provide variations on process steps, e.g., vary decision rules, activities and timing. Such changes can create different experiences for the participants or can be designed to identify or focus on different aspects of process improvement techniques and variation reduction.

After the set of instructions are disseminated, the instructor has the students initiate the simulation. The simulation is played out in a manner such that the work product created by each participant is not observable by the other participants. The work product should be documented, however, so that data relating to various aspects of the work product can be later ascertained. For example, various dimensions of information relating to the work product or activities underlying the work product can include the amount of time taken for the process step(s), materials used or consumed, expertise required, transportation or movements required, and the like. In the preferred embodiment of the method, the business process is simulated solely over electronic mail on the client computers 105. Each e-mail is time-stamped and stored in the server 110 and provides a log of the work flow for the simulation. Each e-mail also can be reviewed by the instructor in the event the simulation needs to be stopped and the process reviewed with the students.

As the simulation proceeds, the students/participants each receive information and act on the information according to the decision rules of their respective roles. By transforming or creating new information based on the received information and the simulation's specific decision rules, the participants generate an output, e.g., a series of fully negotiated leases, including data relating the process steps, e.g., data associated with the e-mails such as who the author of the email may be, to whom the emails are addressed, the content of the messages, the elapsed time for preparing the email messages. The output taken as a whole provides documentation of the overall process.

In the lease example, the documentation of the lease and the data reflecting the process steps taken and by whom the process steps are conducted, describes the process even though the participants themselves may not be able to ascertain the overall process based solely on consideration of their individual roles. The data, for example, the e-mails, can then be gathered, organized, reviewed and analyzed to determine how the simulation progressed and to determine various aspects of the process. For example, the process may be mapped or diagramed in a variety of ways for analysis. The techniques of process mapping and associated analysis of relevant data generated by the simulation are well-known to practitioners of continuous process improvement. In addition, various constraints, errors, variability or waste present in the simulation can be uncovered by reviewing the generated data. The participants practice their process improvement techniques by applying them to the data and revising the initial set of instructions. The modifications to the instructions based on the results of the participant's process improvement analyses are then incorporated into a second simulation. By re-running the simulation, the participants thus experience the effect (positive or negative) of the process changes, i.e., the new set of instructions, to determine if the changes effected improvements in the process. This cycle can be conducted repeatedly as a learning process until the desired expertise in application of process improvement techniques is achieved.

During the simulation, certain aspects or tasks can be scored depending on a student's decision or outcome of the task. Along with variation of the set of instructions, the desired outcome or student decision for certain tasks can introduce randomness into the process. Thus, students can participate in two simulations and have different outcomes and learn different process improvement skills and techniques.

In one specific example of a process simulation, the instructor develops the preliminary information for the students to negotiate a lease for a new store. One goal of the simulation being reduction of cycle time, i.e., the time it takes to sign the lease, and to get development of the new store underway. The instructor also develops a set of instructions for each role, e.g., buyer, attorney, and landlord, or process step involved in the process and disseminates the set of instructions to the appropriate student playing the particular role.

As the simulation begins, the students exchange e-mails to negotiate the lease and to get the lease signed. A student receives an e-mail, processes it according to the set of instructions for his role, and forwards or responds with another e-mail to another student. That student processes the e-mail according to the set of instructions for his role, and forwards or responds with another e-mail to another student. This process continues until the lease is signed. In the example of a commercial lease, example process steps that participants may be asked to conduct could include choosing a location for the hypothetical store, the amount of rent to be paid to the landlord, the services that the landlord will provide for the store, what happens if the building is damaged, termination provisions, etc.

In order to reduce the amount of time that the simulation takes to generate an output, for example a series of actions to represent a fully executed lease, the simulation can be pre-populated with partially completed email strings. Such partially completed communications would represent work in progress or inventory of the process. This pre-loading of the simulation is desirable so that participants having a role sequentially later in the overall simulated process may not have to wait so long before becoming actively engaged in the simulation.

When the simulation is completed, or when the instructor determines that the simulation has generated a sufficient output or body of data and ceases the simulation by halting the process steps, the students can then review the various communications between the participants. In the preferred embodiment the communications are the email strings to gather the related data, which documents the simulated process, e.g., the negotiating leases. With this data, the students can identify the process and the various constituent process steps. The participants can then apply process improvement techniques in view of the stated business objectives and changes in the process/process steps. The changes can be tested by re-running the simulation to see if the changes result in improvements to the lease negotiation process.

During the simulation, scores can be assigned to certain tasks to indicate how well the students negotiated. For example, a score can be given to the amount of rent the student playing the role of the buyer agrees to pay. A score also may be given to the type of provisions included in the lease (e.g., the favorability to landlord or buyer). A score also may be given based on the amount of time elapsed to get the lease signed. The overall score at the end of the simulation can provide an indication of how well the students performed the process.

Various features and advantages of the invention are set forth in the following claims.

What is claimed is:

1. A method of simulating a process, the method comprising:
developing preliminary information related to the process;
assigning a role to each of a plurality of students;
transmitting a set of instructions relating to the assigned role to the corresponding student;
transmitting only electronic mail messages between the students to carry out the process;
storing the electronic mail messages; and
reviewing the electronic mail messages to determine how the process can be improved.

2. The method as set forth in claim 1, wherein the process is negotiating a lease for a business.

3. The method as set forth in claim 1, wherein determining how the process can be improved includes determining where one or more “choke” points exist in the process, and further comprising eliminating the “choke” points.

4. The method as set forth in claim 1, wherein the electronic mail messages are time-stamped and provide data to the students.

5. The method as set forth in claim 1, further comprising re-running the simulation by implementing the identified improvements to the process.

6. The method as set forth in claim 5, further comprising determining whether the identified improvements improved the process.

7. The method as set forth in claim 1, further comprising assigning a score to at least one task of the process.

8. The method as set forth in claim 7, wherein a score can be assigned to a length of time to complete the process.

9. A method of simulating a process, the method comprising:
transmitting preliminary information related to the process to a plurality of students;
assigning a role to each of the plurality of students, the roles related to the process;
transmitting a set of instructions relating to the assigned role to the corresponding student;
transmitting only electronic mail messages between the students to carry out the process;
storing the electronic mail messages;
reviewing the stored electronic mail messages to determine how the process can be improved;
re-running the process with the identified improvements; and
determining whether the identified improvements improved the re-run process.

10. The method as set forth in claim 9, wherein the process is negotiating a lease for a business.

11. The method as set forth in claim 9, wherein determining how the process can be improved includes determining where one or more “choke” points exist in the process, and further comprising eliminating the “choke” points.

12. The method as set forth in claim 9, wherein the electronic mail messages are time-stamped and provide data to the students.

13. The method as set forth in claim 9, further comprising assigning a score to at least one task associated with the process.

14. The method as set forth in claim 13, wherein a score can be assigned to a length of time to complete the process.
